(19) United States
(12) Patent Application Publication
(10) Pub. No.: US 2016/0079584 A1
(43) Pub. Date: Mar. 17, 2016

(54) RECHARGEABLE BATTERY

(71) Applicant: SAMSUNG SDI CO., LTD., Yongin-si (KR)

(72) Inventors: Jin-Hyon Lee, Yongin-si (KR); Ji-Woon Lee, Yongin-si (KR); Eun-Young Goh, Yongin-si (KR); Sang-In Park, Yongin-si (KR); Sung-Yong Kim, Yongin-si (KR); Jin-Seon Shin, Yongin-si (KR); Jong-Ki Lee, Yongin-si (KR)

(21) Appl. No.: 14/738,674

(22) Filed: Jun. 12, 2015

(30) Foreign Application Priority Data
Sep. 12, 2014 (KR) 10-2014-0121209

(51) Int. Cl. H01M 2/30; H01M 2/06; H01M 10/04

(52) U.S. Cl. CPC H01M 2/30; H01M 10/0431; H01M 2/06

(57) ABSTRACT

One or more embodiments of the present invention provide a rechargeable battery for allowing electrode terminals and electrode tabs to be easily coupled. A rechargeable battery according to one or more embodiments of the present invention include: an electrode assembly having first and second electrodes at opposite surfaces of a separator and wound about an axis; a first terminal coupled to the first electrode through a first tab; a second terminal coupled to the second electrode through a second tab; a case accommodating the electrode assembly and defining first and second openings at its opposite ends; a first gasket between the first terminal and the first opening sealing the first opening and allowing the first terminal to protrude outside of the case; and a second gasket between the second terminal and the second opening sealing the second opening and allowing the second terminal to protrude outside of the case.

### CROSS-REFERENCE TO RELATED APPLICATION

This application claims priority to and the benefit of Korean Patent Application No. 10-2014-0121209 filed in the Korean Intellectual Property Office on Sep. 12, 2014, the entire contents of which are incorporated herein by reference.

### BACKGROUND

1. Field

The present disclosure relates to a rechargeable battery.

2. Description of the Related Art

Rechargeable batteries can be classified into small-size cylindrical and prismatic types, large-sized prismatic types, etc., depending on their sizes and capacities.

As technology develops and demand for mobile devices increases, demand for small-sized cylindrical and prismatic rechargeable batteries as an energy source has also increased.

In general, a rechargeable battery includes an electrode assembly formed by disposing electrodes at opposite sides of a separator and then winding them in a jelly roll shape, a case for accommodating the electrode assembly, and a cap assembly for closing an opened side of the case.

With advancements in technology for mobile devices, peripheral devices such as touch pens and stylus pens, each with respective diameters of several millimeters, have been developed and used. However, a rechargeable battery with an ultra-small diameter for use in such devices has not been previously developed.

In addition, in order to weld a negative electrode tab to the bottom of a case of a cylindrical type rechargeable battery, a welding rod is typically inserted through a core part of the rechargeable battery.

A rechargeable battery with an ultra-small diameter has a core with a very small diameter.

Accordingly, welding is very difficult because the welding rod may be inserted through the core.

The above information disclosed in this Background section is only for enhancement of understanding of the background of the present disclosure and therefore it may contain information that does not form the prior art that is already known in this country to a person of ordinary skill in the art.

### SUMMARY

One or more embodiments of the present disclosure provide a pin type rechargeable battery having an ultra-small diameter.

One or more embodiments of the present disclosure provide a rechargeable battery that allows electrode terminals and electrode tabs to be easily coupled.

A rechargeable battery according to an exemplary embodiment of the present disclosure includes: an electrode assembly with first and second electrodes at opposite surfaces of a separator wound about an axis; a first terminal coupled to the first electrode through a first tab; a second terminal coupled to the second electrode through a second tab; a case accommodating the electrode assembly and having first and second openings at opposite ends of the case; a first gasket between the first terminal and the first opening to seal the first opening and allow the first terminal to protrude outside of the case; and a second gasket between the second terminal and the second opening to seal the second opening and allow the second terminal to protrude outside of the case.

A length of the first tab may be longer than a first gap between the electrode assembly and the first terminal.

A length of the second tab may be longer than a second gap between the electrode assembly and the second terminal.

The case may include a first beading portion depressed toward a diametrical center of the first opening from a connecting portion of the first terminal and the first tab.

The case may include a second beading portion depressed toward a diametrical center of the second opening from the connecting portion of the second terminal and the second tab.

An uncoated region of the first electrode and the first tab may be welded to each other, and an uncoated region of the second electrode and the second tab may be welded to each other.

An uncoated region of the first electrode and the first tab may be integrally formed, and an uncoated region of the second electrode and the second tab may be integrally formed.

An uncoated region of the first electrode and an uncoated region of the second electrode may be at or along a center of the electrode assembly and an outermost side of the electrode assembly, respectively.

An uncoated region of the first electrode and an uncoated region of the second electrode may each be at or along a respective outermost side of the electrode assembly.

An uncoated region of the first electrode and an uncoated region of the second electrode may each be at a center of the electrode assembly.

The case may have a diameter of 2 mm to 5 mm.

The first electrode and the second electrode may be wound two to five times.

As described above, in an exemplary embodiment of the present disclosure, since the first gasket is between the first terminal coupled to the first electrode of the electrode assembly through the first tab and the first opening of the case and the second gasket is between the second terminal coupled to the second electrode of the electrode assembly through the second tab and the second opening of the case, the first and second terminals each protrude outside of the case and seal the first and second openings, respectively, thereby forming the pin type of rechargeable battery having an ultra-small diameter.

In addition, the first tab is coupled to the first terminal and combined to the first opening of the case while being coupled to the first terminal with the first gasket therebetween, and the second tab is coupled to the second terminal and combined to the second opening of the case while being coupled to the second terminal with the second gasket therebetween, thereby allowing the first and second terminals to be easily coupled to the first and second tabs, respectively.

### BRIEF DESCRIPTION OF THE DRAWINGS

FIG. 1 is a perspective view of a rechargeable battery according to an embodiment of the present invention.

FIG. 2 is an exploded perspective view of FIG. 1.

FIG. 3 is a cross-sectional view of FIG. 1 taken along the line

FIG. 4 is an exploded perspective view of an electrode assembly of FIG. 2.

FIG. 5 is an exploded perspective view of a rechargeable battery according to another embodiment of the present invention.

FIG. 6 is an exploded perspective view of a rechargeable battery according to another embodiment of the present invention.

FIG. 7 is an exploded perspective view of an electrode assembly of FIG. 6.

### DETAILED DESCRIPTION

The present invention will be described more fully hereinafter with reference to the accompanying drawings, in which exemplary embodiments of the invention are shown.

As those skilled in the art would realize, the described embodiments may be modified in various different ways, all without departing from the spirit or scope of the present invention.

The drawings and description are to be regarded as illustrative in nature and not restrictive, and like reference numerals designate like elements throughout the specification.

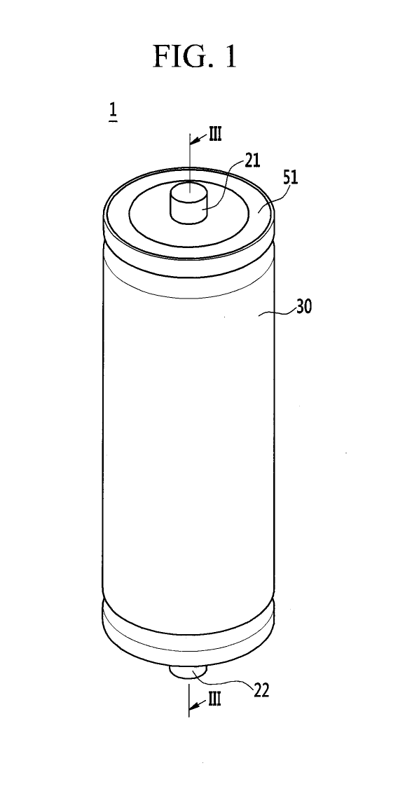

FIG. 1 is a perspective view of a rechargeable battery according to one or more embodiments of the present invention.

Referring to FIG. 1, the rechargeable battery 1 is a pin type battery having a diameter of several millimeters. For example, the diameters may be between about 2 mm to 5 mm.

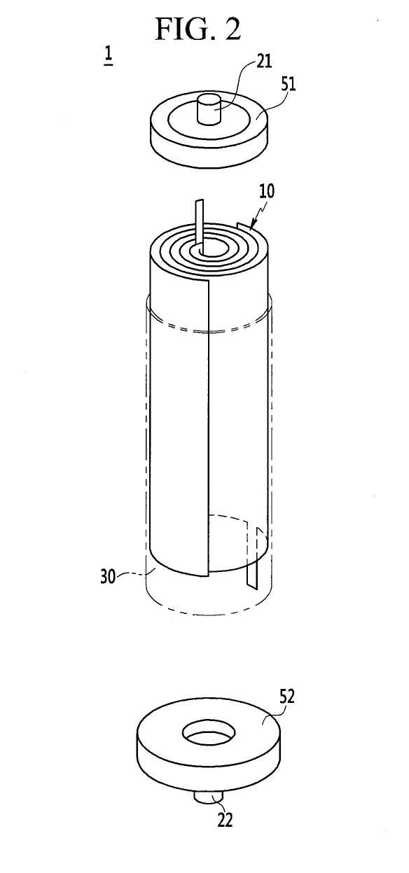

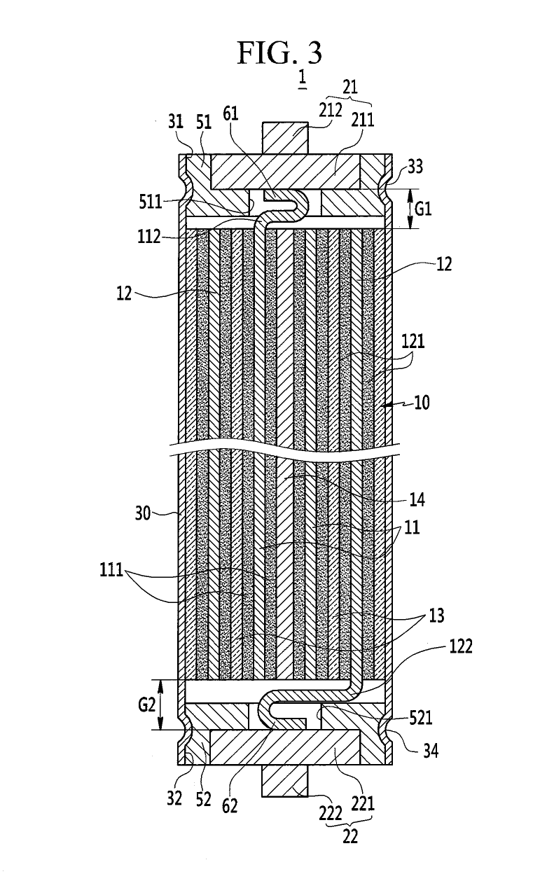

FIG. 2 is an exploded perspective view of FIG. 1, and FIG. 3 is a cross-sectional view of FIG. 1 taken along the line

Referring to FIGS. 2 and 3, the rechargeable battery 1 includes an electrode assembly 10 for charging and discharging, first and second terminals 21 and 22 coupled to the electrode assembly 10, a case 30 for accommodating the electrode assembly 10 and an electrolyte solution, and first and second gaskets 51 and 52 between the first and second terminals 21 and 22, respectively, and the case 30.

The electrolyte solution may be inserted into the case 30 to interact with the electrode assembly 10.

The electrode assembly 10 includes a first electrode 11 and a second electrode 12 at opposite sides of a separator 13. The separator 13 is an insulator.

The electrode assembly 10 is formed by winding the first electrode 11, the second electrode 12, and the separator 13 in a jelly roll configuration.

For example, the first and second electrodes 11 and 12 and the separator 13 may be wound two to five times around a core 14.

The diameter of the rechargeable battery and the thickness of the separator 13 and the first and second electrodes 11 and 12 may limit the number of winds of the electrode assembly 10 to between and two and five.

For example, when the first and second electrodes 11 and 12 are wound fewer than two times, the rechargeable battery 1 may not provide a required capacity, and the diameter of the rechargeable battery 1 may exceed 5 mm when the first and second electrodes 11 and 12 are wound more than five times.

The first and second electrodes 11 and 12 include coated regions 111 and 121 where an active material is coated on opposite surfaces of a current collector formed of a thin metal foil (for example, copper (Cu) and aluminum (Al) foils), and uncoated regions 112 and 122 where the active material is not coated thereon to expose the current collector.

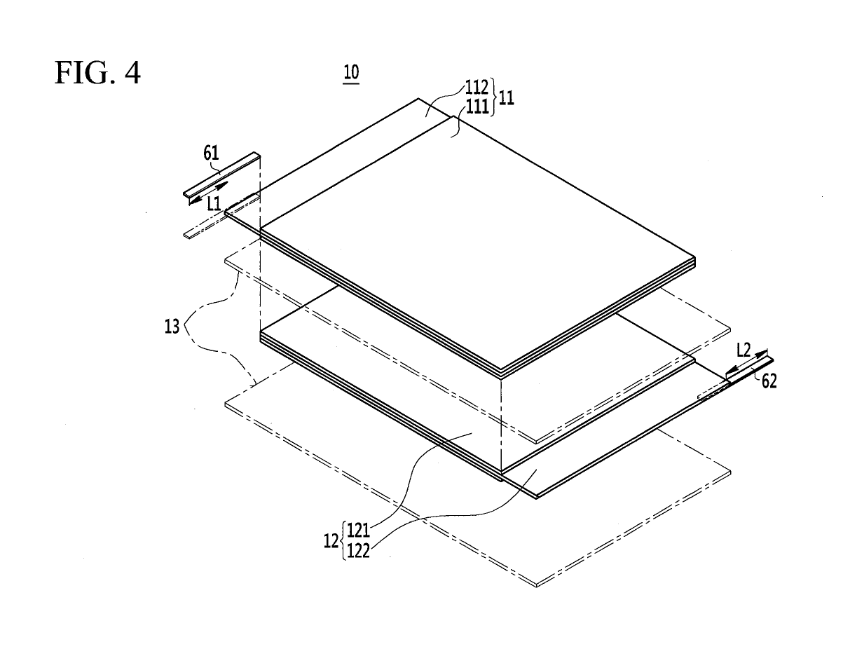

FIG. 4 is an exploded perspective view of the electrode assembly of FIG. 2.

Referring to FIGS. 2 to 4, the first terminal 21 is coupled to the uncoated region 112 of the first electrode 11 through a first tab 61.

The second terminal 22 is coupled to the uncoated region 122 of the second electrode 12 through a second tab 62.

The case 30 is provided with a first opening 31 and a second opening 32 at its opposite ends to accommodate the electrode assembly 10.

For example, the case 30 is cylindrically formed to accommodate the cylindrically-formed electrode assembly 10.

The rechargeable battery 1 is a pin type battery having an ultra-small diameter wherein its outer diameter is set by the case 30.

The first terminal 21 is coupled to the first electrode 11 of the electrode assembly 10 by the first tab 61 through the first opening 31. Similarly, the second terminal 22 is coupled to the second electrode 12 of the electrode assembly 10 by the second tab 62 through the second opening 32.

For example, the first tab 61 is welded to the uncoated region 112 of the first electrode 11, and the second tab 62 is welded to the uncoated region 122 of the second electrode 12.

The first terminal 21 may include a plate portion 211 that seals the first opening 31 and protruding portion 212 that protrudes from the plate portion 211. Similarly, second terminal 22 may include a plate portion 221 that seals the second opening 32 and protruding portion 222 that protrudes from the plate portion 221.

The plate portions 211 and 221 each allow the first and second terminals 21 and 22, respectively, to be easily coupled to the first and second tabs 61 and 62, respectively, and the protruding portions 212 and 222 each allow the first and second terminals 21 and 22, respectively to be easily coupled to a device that uses the rechargeable battery 1.

The first gasket 51 is between the first terminal 21 and the first opening 31 of the case 30. The first gasket 51 electrically insulates the first terminal 21 from the first opening 31 of the case 30 while sealing the first opening 31 along with the first terminal 21, and allows the protruding portion 212 of the first terminal 21 to protrude outside of the case 30.

The second gasket 52 is between the second terminal 22 and the second opening 32 of the case 30. The second gasket 52 electrically insulates the second terminal 22 from the second opening 32 of the case 30 while sealing the second opening 32 along with the second terminal 22, and allows the protruding portion 222 of the second terminal 22 to protrude outside of the case 30.

A length L1 of the first tab 61 (i.e., the length of the first tab 61 protruding from the uncoated region 112) is longer than a first gap G1 between one end of the electrode assembly 10 and the first terminal 21.

Accordingly, the first tab 61 may electrically couple the uncoated region 112 of the first electrode 11 and the first terminal 21.

For this purpose, the first gasket 51 includes a first tab hole 511.

The first tab 61 is curved according to the first tab hole 511.

A length L2 of the second tab 62 (i.e., the length of the second tab 62 protruding from the uncoated region 122) is longer than a second gap G2 between the other end of the electrode assembly 10 and the second terminal 22.

Accordingly, the second tab 62 electrically couples the uncoated region 122 of the second electrode 12 and the second terminal 22.

For this purpose, the second gasket 52 includes a second tab hole 521.

The second tab 62 is curved according to the second tab hole 521.

For example, the first gasket 51 is combined to the first terminal 21 that is coupled to the first electrode 11 of the electrode assembly 10 through the first tab 61, and the second gasket 52 is combined to the second terminal 22 that is coupled to the second electrode 12 of the electrode assembly 10 through the second tab 62.

The first and second gaskets 51 and 52 are each respectively fitted into the first and second openings 31 and 32 of the case 30 and respectively fixed to the first and second openings 31 and 32 of the case 30 by a crimping process.

First and second beading portions 33 and 34 are each formed in the case 30 and respectively depressed toward diametrical centers of the first and second openings 31 and 32.

The first and second beading portions 33 and 34 respectively fix the position of the first and second gaskets 51 and 52 in the first and second openings 31 and 32 of the case 30. The first and second gaskets 51 and 52 seal the first and second openings 31 and 32, respectively, and allow the first and second terminals 21 and 22 to protrude outside of the case 30.

For example, the first and second beading portions 33 and 34 are respectively provided in the first and second openings 31 and 32 of the case 30 to correspond to respective connecting portions between the first and second terminals 21 and 22 and the first and second tabs 61 and 62.

The case 30 may be formed of a metal, for example, aluminum or stainless steel, such that it is processed to form the first and second beading portions 33 and 34.

The first beading portion 33 is depressed toward the diametrical center near the interface of the first terminal 21 and the first tab hole 511, and second beading portion 34 is depressed toward the diametrical center near the interface of the second terminal 22 and the second tab hole 521.

Accordingly, while the first and second beading portions 33 and 34 of the case 30 each compress the first and second gaskets 51 and 52, respectively, fastening forces of the first and second terminals 21 and 22 and the first and second beading portions 33 and 34 can be further increased.

In one or more embodiments, the first and second gaskets 51 and 52 may each be a rubber cap.

As described above, the first and second tabs 61 and 62 are each respectively coupled to the first and second terminals 21 and 22 by coupling the first and second tabs 61 and 62 to the first and second electrodes 11 and 12 of the electrode assembly 10, respectively, and inserting one side of the electrode assembly 10 into the case 30. The first and second gaskets 51 and 52 are combined to the first and second terminals 21 and 22, respectively, and the first and second gaskets 51 and 52 are each respectively combined to the first and second openings 31 and 32, and the first and second beading portions 33 and 34 are each depressed, thereby assembling the rechargeable battery 1.

For example, while the first and second openings 31 and 32 of the case 30 are opened, the first and second tabs 61 and 62 are respectively coupled to the first and second terminals 21 and 22, thereby allowing the first and second terminals 21 and 22 to be easily coupled to the first and second tabs 61 and 62.

Subsequently, the first and second gaskets 51 and 52 combined to the first and second terminals 21 and 22, respectively, are inserted into the first and second openings 31 and 32 of the case 30 to form the first and second beading portions 33 and 34, thereby making assembly of the rechargeable battery 1 easy.

Various exemplary embodiments of the present disclosure follow.

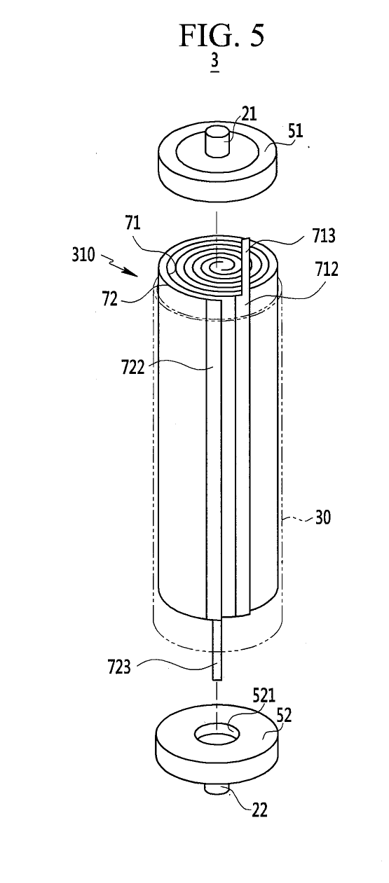

FIG. 5 is an exploded perspective view of a rechargeable battery according to one or more embodiments of the present invention.

Referring to FIG. 5, the rechargeable battery 3 includes an uncoated region 712 and a first tab 713 of a first electrode 71 that are integrally formed, and an uncoated region 722 and a second tab 723 of a second electrode 72 that are integrally formed.

Accordingly, welding of the first and second tabs 713 and 723 to the uncoated regions 712 and 722, respectively, can be reduced relative to the welding required for the rechargeable battery 1.

For example, the rechargeable battery 1 described above includes the uncoated region 112 of the first electrode 11 and the uncoated region 122 of the second electrode 12 that are respectively provided at a center and an outermost side of the electrode assembly 10.

In contrast the rechargeable battery 3 includes the uncoated region 712 of the first electrode 71 and the uncoated region 722 of a second electrode 72 that are provided at an outermost side of an electrode assembly 310.

In one or more embodiments, one side of the electrode assembly 310 is inserted into the case 30 and the first and second tabs 713 and 723 are each welded to the first and second electrodes 71 and 72, respectively. The first and second tabs 713 and 723 each curve toward a center direction of the electrode assembly 310 from an outer side thereof, such that they are inside of the first and second tab holes 511 and 521, respectively.

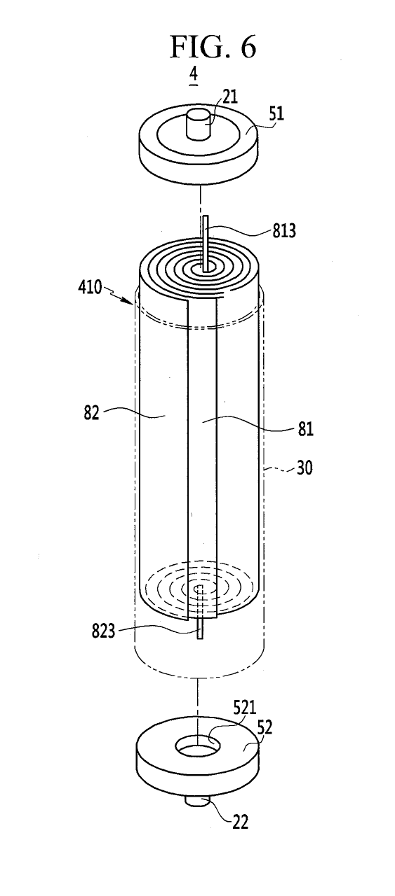

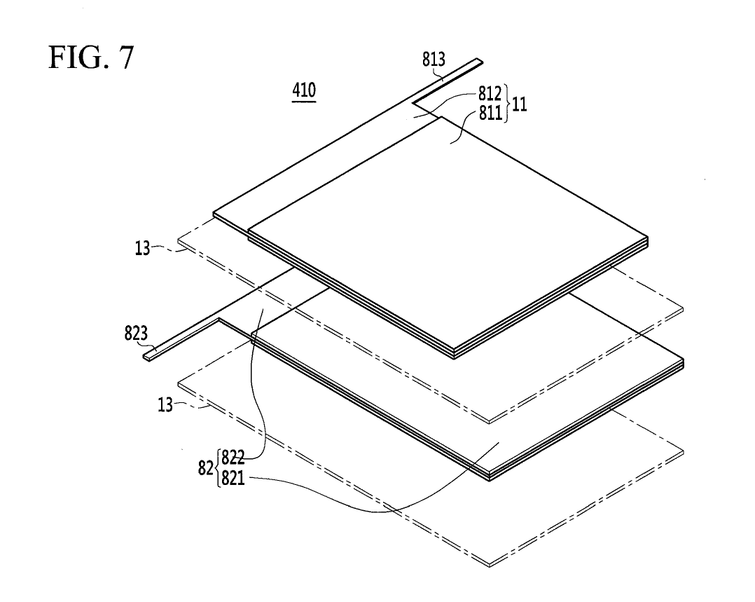

FIG. 6 is an exploded perspective view of a rechargeable battery according to another embodiment of the present disclosure, and FIG. 7 is an exploded perspective view of an electrode assembly of FIG. 6.

Referring to FIGS. 6 and 7, the rechargeable battery 4 includes an uncoated region 812 of a first electrode 81 and an uncoated region 822 of a second electrode 82 at a center of an electrode assembly 410.

The uncoated region 812 of the first electrode 81 and a first tab 813 are integrally formed, and the uncoated region 822 of the second electrode 82 and a second tab 823 are integrally formed.

Since the uncoated regions 812 and 822 are at the center of the electrode assembly 410, the lengths of the first and second tabs 813 and 823 that respectively connect the uncoated regions 812 and 822 with the first and second terminals 21 and 22 can be shortened.

In one or more embodiments, when one side of the electrode assembly 410 is inserted into the case 30 and the first and second tabs 813 and 823 are welded to the first and second electrodes 81 and 82, respectively, the first and second tabs 813 and 823 extend from the center of the electrode assembly 410 such that they are inside the first and second tab holes 511 and 521.

While this invention has been described in connection with what is presently considered to be practical example embodiments, it is to be understood that the invention is not limited to the disclosed embodiments, but, on the contrary, is intended to cover various modifications and equivalent arrangements included within the spirit and scope of the appended claims.

### DESCRIPTION OF SYMBOLS

1, 3, 4: rechargeable battery

10, 310, 410: electrode assembly

11, 71, 81: first electrode

12, 72, 82: second electrode

13: separator

14: core

21: first terminal

22: second terminal

30: case

31: first opening

32: second opening

33, 34: first, second beading portion

51, 52: first, second gasket

61, 713, 813: first tab

62, 723, 823: second tab

111, 121, 811, 821: coated region

112, 122, 712, 722, 812, 822: uncoated region

211, 221: plate portion

212, 222: protruding portion

511: first tab hole

521: second tab hole

G1, G2: first, second gap

L1, L2: length

What is claimed is:

1. A rechargeable battery comprising:
an electrode assembly comprising first and second electrodes at opposite surfaces of a separator and wound about an axis;
a first terminal coupled to the first electrode through a first tab;
a second terminal coupled to the second electrode through a second tab;
a case accommodating the electrode assembly and defining first and second openings at opposite ends of the case;
a first gasket between the first terminal and the first opening sealing the first opening and allowing the first terminal to protrude outside of the case; and
a second gasket between the second terminal and the second opening sealing the second opening and allowing the second terminal to protrude outside of the case.

2. The rechargeable battery of claim 1, wherein a length of the first tab is longer than a first gap between the electrode assembly and the first terminal.

3. The rechargeable battery of claim 1, wherein a length of the second tab is longer than a second gap between the electrode assembly and the second terminal.

4. The rechargeable battery of claim 1, wherein the case comprises a first beading portion and wherein the first beading portion is depressed toward a diametrical center of the first opening from a connecting portion of the first terminal and the first tab.

5. The rechargeable battery of claim 1, wherein the case comprises a second beading portion and wherein the second beading portion is depressed toward a diametrical center of the second opening from the connecting portion of the second terminal and the second tab.

6. The rechargeable battery of claim 1, wherein an uncoated region of the first electrode is welded to the first tab and an uncoated region of the second electrode is welded to the second.

7. The rechargeable battery of claim 1, wherein an uncoated region of the first electrode and the first tab are integrally formed and an uncoated region of the second electrode and the second tab are integrally formed.

8. The rechargeable battery of claim 1, wherein an uncoated region of the first electrode is at a center of the electrode assembly and an uncoated region of the second electrode is at an outer side of the electrode assembly.

9. The rechargeable battery of claim 1, wherein an uncoated region of the first electrode and an uncoated region of the second electrode are at an outer side of the electrode assembly.

10. The rechargeable battery of claim 1, wherein an uncoated region of the first electrode and an uncoated region of the second electrode are at a center of the electrode assembly.

11. The rechargeable battery of claim 1, wherein the case has a diameter between about 2 mm to 5 mm.

12. The rechargeable battery of claim 1, wherein the first electrode and the second electrode are wound between two to five times.
